(19) United States
(12) Patent Application Publication
(10) Pub. No.: US 2024/0122322 A1
(43) Pub. Date: Apr. 18, 2024

(54) PORTABLE LUNCHBOX

(71) Applicant: Nexenic AG, Winterthur (CH)

(72) Inventors: Reto MUHL, Schaffhausen (CH); Claudio RIBEIRO RUIZ, Zürich (CH); Johannes Matthäus Maria HOFER, Ottoberg (CH)

(73) Assignee: Nexenic AG, Winterthur (CH)

(21) Appl. No.: 18/276,995

(22) PCT Filed: Feb. 9, 2022
(86) PCT No.: PCT/EP2022/053127

§ 371 Date: Aug. 11, 2023

(30) Foreign Application Priority Data
Feb. 12, 2021 (EP) 21156781.3

(51) Int. Cl. A45C 11/20; A45C 13/00; A47J 27/04

(52) U.S. Cl. CPC A45C 11/20; A45C 13/008; A47J 27/04; A47J 2027/046

(57) ABSTRACT

A lunchbox having a base part (2) having a food cavity (40) for receiving food; a lid (1) sealingly, closing the base part (2); and a closure (3) for closing the lunchbox. The closure (3) has at least one locking element. At least one lifting-element clamp (30, 31) is provided, which lifts the lid (1) from the base part (2.) when the locking element is in a position in which it is moved with respect to a closed position. Preferably the locking element and the lifting element are a single component formed by a clamp. This lunchbox is suitable for transporting, storing and preparing meals by optionally heating and steaming the food. The lunchbox allows safe opening of the lid without the risk of scalding the user and also ensures optimal sealing.

### CROSS REFERENCE TO RELATED APPLICATIONS

This application is a National Stage of International Application No. PCT/EP2022/053127 filed Feb. 9, 2022, claiming priority based on European Patent Application No. 21156781.3 filed Feb. 12, 2021.

### TECHNICAL FIELD

The present invention relates to a lunchbox, in particular a portable lunchbox, and in particular for storing, transporting and preparing food.

### PRIOR ART

Lunchboxes enable meals to be carried as desired to a place of work or study, or any other location, and to be consumed there in the desired manner. There are lunchboxes which simply ensure a sealed packaging for storage. Other types of lunchboxes are configured to be insulating so that the meals can be kept hot or cold. Lunchboxes which have an integrated heating device in order to heat up the meals in situ are also known. Developed lunchboxes also permit meals to be steamed.

WO 2020/064848 discloses such a developed portable lunchbox for storing, transporting and preparing food. The lunchbox has a food cavity for receiving food, a heating cavity for receiving water, a heating element for heating up the water and a mechanical switching device which can be switched from a first state into a second state. In the first switching state the food can be heated up and in the second switching state the food can be steamed, i.e. steam applied thereto. This lunchbox has a base part into which a shell comprising the food can be inserted, and a lid which sealingly closes the base part when the shell is inserted. Pivotable tabs, in particular flaps, are present for the sealed locking of the lunchbox. Since they are arranged on the lid, the tabs serve at the same time for manually lifting and removing the lid from the base part.

WO 2015/177726 A1 describes a lunchbox for storing, for transporting and for heating up food, having a pressure compensation element in the upper face of the lid of the lunchbox.

WO 2015/096175 A1 discloses a lunchbox for storing, for transporting and for heating up food, having a pressure relief valve which is arranged in a side wall of the base part.

EP 1 780 140 B1 discloses a container for storing and for transporting food, having a base part and a sealingly locking lid. The lid is locked by means of two clamp-shaped slide bars. The two slide bars are held on two opposing sides on a peripheral edge of the lid. The slide bars encompass a peripheral edge of the base part and are movable relative to one another with respect to the lid and the base part, whereby the lid is fixed to the base part.

EP 1 541 485 A1 discloses a container, in particular for storing butter or cheese, having a base plate and a cover. The cover has a peripheral lower edge. A rocker with a latching element and two lever arms is integrally formed on the base plate. By pressing downwardly on the latching element, ends of the lever arms are pushed upwardly and the cover is lifted up. At the same time, the latching element is pushed outwardly and the cover is released.

DE 94 08 536 U1 discloses a pressure cooker with a pressure relief opening which is arranged in a lid handle and which is adjustable by means of a movable small plate.

A lunchbox which is closed in an airtight manner and which contains hot food is not always simple to open, in particular when the food has been heated in the interior of the lunchbox itself. When opened, steam is initially forced out of the lunchbox, which at best steams up the glasses of the user and at worst scalds the fingers or other body parts. Moreover, generally an overpressure prevails in the interior of the lunchbox so that when the lunchbox is opened, liquid, in particular grease, can spray out and scald the user or anyone in the vicinity thereof. Additionally, it is not desirable if the steam or liquid which sprays out soils a table surface or objects adjacent to the lunchbox.

Moreover, the seal of the lunchbox always has to be ensured when storing, transporting and preparing the meals.

### SUMMARY OF THE INVENTION

It is, therefore, an object of the invention to provide a lunchbox which can be reliably closed with a tight seal and which can be opened in a safe manner and with little expenditure of force.

In a first variant of the solution, the lunchbox according to the invention comprises a base part that has a food cavity for receiving food, a lid that sealingly closes the base part and a closure for closing the lunchbox by fixing the lid on the base part. The closure comprises at least one locking element that can be moved from a closed position into an open position with respect to the base part and the lid. At least one lifting element is provided, said lifting element lifting the lid from the base part when the locking element is in a position in which it is moved with respect to the closed position.

Thanks to the locking element, the lid can be sealingly fixed to the container. The locking element preferably can be configured such that it exerts a contact pressure, for example by pushing the lid downwardly onto the base part. For example, the locking element can be configured as at least one clamp or as at least one flap element.

Thanks to the lifting element, the lid can be lifted, such that the lid can be gripped by hand in a simple manner and the lunchbox can be fully opened. Depending on the embodiment, this lifting takes place when the closure is already partially open or only when the closure is fully open. Depending on the embodiment, the lifting takes place automatically, for example by the lifting element being pivoted by its own weight and thus lifting the lid. Preferably, however, the lifting element is pushed by hand upwardly or downwardly in order to lift the lid.

In preferred embodiments, the locking element or the lifting element serves as a grip for the further lifting and removal of the lid. If the locking element or the lifting element has at least one clamp, this has the advantage that the hands are at a greater distance from the residual steam and hot condensed water. If the locking elements, in particular the clamps, are arranged on the lid, in preferred embodiments they can be used as handles for lifting and removing the lid.

In preferred embodiments, the locking element and the lifting element are configured to be as aligned as possible with the outer contour of the remaining lunchbox. The lunchbox preferably has no protruding components or hardly any protruding components. As a result, the lunchbox can be simply stowed in a bag or backpack and transported. As a result, the lunchbox also has an attractive design.

Preferably, the locking element and the lifting element are formed by the same component. In preferred embodiments, this common single component is a clamp. Preferably, two clamps are present, the clamps each forming a locking element and a lifting element per se.

In a preferred embodiment, the at least one locking element comprises a clamp with two arms and a web connecting the two arms. The clamp can be moved from the closed position into the open position with respect to the base part and the lid, in the longitudinal direction of the arms. The at least one lifting element is also the clamp, wherein the clamp is pivotable when it is in the position in which it is moved with respect to the closed position. A pivoting of the clamp with respect to the base part and the lid lifts the lid from the base part.

Depending on the embodiment, only an opening between the interior of the lunchbox and the surroundings is opened up by lifting the lid. In other embodiments, a gap is generated between the base part and the lid. In preferred embodiments, the lid which is lifted from the base part at least partially releases the seal between the lid and the base part so that a further lifting of the lid by hand is facilitated.

If the lid is already lifted when the closure is partially open, the lunchbox cannot be fully opened, for example the lid cannot yet be fully lifted and removed from the base part. This has the advantage that any opening which has been produced can be kept small in a defined manner. An overpressure in the container and/or steam can escape in a controlled manner until the container is fully opened, without the user being scalded. Depending on the embodiment, the steam escapes exclusively through the released seal between the base part and the lid or in other embodiments exclusively via an air relief opening and/or a pressure relief valve. Further embodiments are combinations of these two embodiments, so that the steam escapes via different openings.

If the lid is lifted only when the closure is fully open, a clearly identifiable position is reached. As before, the user can wait until sufficient steam has escaped. If unheated food is present in the container, however, and no overpressure or steam is present, the user does not have to wait unnecessarily but can remove the lid very rapidly. Due to the lifting of the lid by means of the closure, the lid can then be removed from the base part with little expenditure of force.

In preferred embodiments, the lunchbox has at least one air through-opening which leads outwardly from an interior of the base part, wherein in the closed position the at least one locking element sealingly closes the at least one air through-opening, and wherein in a position in which it is moved with respect to the closed position the at least one locking element opens up the at least one air through-opening.

This air through-opening permits an optimally sealed closure of the lid. When the closure is locked, when the lid is already positioned on the base part with the sealing ring located therebetween, air can escape from the interior of the lunchbox as before. As a result, the closure is facilitated.

Additionally, due to this air through-opening hot air or steam can already escape before the lid is lifted. Since the locking element opens up this opening, but the hands of the user hold the locking element during the opening, a scalding of the user is optimally avoided. This is when the locking element is a clamp, in particular.

If a negative pressure prevails in the lunchbox, the air through-opening permits a pressure compensation before the lid is fully opened or removed.

Preferably, the least one air through-opening is arranged in the lid, wherein preferably the air through-opening leads outwardly from the interior of the lunchbox. As a result, a direct and easily closable connection from the interior into the surroundings is provided in a simple manner.

In preferred embodiments, alternatively or additionally to the air through-opening, the lunchbox has at least one pressure relief valve which leads outwardly from an interior of the base part, wherein at least in the closed position the pressure relief valve is covered by at least one locking element. In contrast to the air through-opening, the pressure relief valve is preferably not sealingly closed but merely covered. As a result it is always ready for use, i.e. even when the lunchbox is fully closed. However, it is protected by the locking element and cannot be damaged or contaminated, in particular when the lunchbox is transported. Moreover, escaping steam can be dispersed along the locking element and thus cannot scald a user by a concentrated exit of steam when the user carries the lunchbox by hand. This is the case when the locking element is a clamp, in particular.

Preferably, the at least one pressure relief valve is arranged in the lid and preferably the pressure relief valve leads outwardly from the food cavity.

In preferred embodiments, the at least one locking element, in particular the clamp, is held on the lid. The lid preferably has a guide which guides the movement and pivoting of the at least one locking element. The guide is preferably formed by protruding ribs and/or grooves and/or ramps and/or projections.

The seal is improved and optimally ensured in embodiments in which the at least one locking element, in particular the clamp, is positioned on a projection or a step of the lid. Due to the positioning, the lid can be pushed sealingly onto the base part in the closed position.

A single locking element is sufficient, in particular but not exclusively, when the lid is pivotably held on an opposing side on the base part.

Preferably, however, the closure has two locking elements, in particular two clamps, which can be moved with respect to the base part and the lid in the longitudinal direction of their arms, wherein the locking elements in a pushed-together state sealingly fix the lid to the base part. Preferably, the two locking elements are configured to be the same in terms of their shape and size and can preferably be pushed together for a common edging of the lid and/or the base part, so that they form a peripheral strip of the lunchbox. The locking elements can preferably be pulled apart in opposing directions so that they can preferably be moved at the same time with respect to the lid and to the base part. The pivoting preferably takes place at the same time or, when manually generated, can also preferably take place at the same time. Preferably, when their free ends are adjacent to one another the locking elements lift the lid together, wherein their webs which are remote from one another are preferably inclined downwardly.

The use of two locking elements, in particular two clamps, also permits a safe opening of the lunchbox even when the lunchbox is held by hand and is not positioned on a support surface. This facilitates the use, for example, on a park bench, when picnicking, in a train, in an aircraft or in a different means of transport.

The lunchbox is configured in a simple embodiment for storing and for transporting food. Depending on the embodiment, the lunchbox is insulated and suitable for cold and hot food.

In preferred embodiments, the lunchbox is configured for heating up, further preferably for preparing, food. In very preferred embodiments, it is configured for storing, for transporting and for preparing food, wherein the preparation preferably selectively takes place by purely heating or by steaming, i.e. the application of steam. Such a lunchbox is disclosed, for example, in WO 2020/064848 A1. The lunchbox according to the invention is preferably a development thereof and preferably has the same or similar components, except for the closure and the elements operatively connected thereto.

In a preferred embodiment, the lunchbox according to the invention thus has a heating element for heating up and/or preparing food. Preferably, the lunchbox has a water cavity for filling with water, wherein the heating element acts on the water cavity. The food can be heated up in the food cavity by heating the water in the water cavity.

Preferably, a gap is formed between the food cavity and the base part so that steam can pass from the water cavity into the food cavity and steam can be applied to the food. The lunchbox thus acts as a steamer. The gap or access preferably can be selectively opened and closed by the user.

The selective use as a steamer can be achieved, for example, by the lid being sealingly positioned on the base part in a first rotary position, such that it seals the gap when the closure is closed with respect to the food cavity, and wherein the lid is positioned on the base part in a second rotary position, such that it opens up the gap when the closure is closed with respect to the food cavity.

Preferably, the food cavity is sealed with respect to the water cavity in the first rotary position of the lid and the food cavity is connected to the water cavity in the second rotary position of the lid, for the purpose of applying steam to the food.

In a preferred embodiment, the base part has a first and a second guide, wherein when the at least one locking element, in particular the clamp, is moved the at least one locking element is guided by the first guide or by the second guide of the base part as a function of the rotary position of the lid. As a result, in both rotary positions it is ensured in a simple manner that the lid is sealingly held on the base part, and a desired contact pressure is present for an adequate seal, depending on the embodiment of the closure.

It is a further object of the invention to provide a lunchbox which can be opened in a safe manner from a sealingly closed state.

In a second variant of the solution, the lunchbox according to the invention has a base part that has a food cavity for receiving food, a lid that sealingly closes the base part, a closure for closing the lunchbox by fixing the lid on the base part and an air through-opening and/or a pressure relief valve. The closure covers the air through-opening and/or the pressure relief valve in a closed state of the lunchbox and the closure opens up the air through-opening and/or the pressure relief valve in an open state of the lunchbox. As a result, an exit of steam and/or a relief of an overpressure is possible when the closure is already open, i.e. before the lid is fully opened. Steam or liquids are thus able to be prevented from escaping in an uncontrolled manner. Splashes onto the hand of the user and thus scalding are prevented. In the case of air through-openings, sealing the openings very late during the locking process permits a simple locking and an optimally sealed closure of the lunchbox.

This lunchbox according to the second variant can have a differently shaped closure. The clamps do not necessarily have to be movable and pivotable. For example, clamps can be used as disclosed in EP 1 780 140 A1. Flaps or other types of locking elements can also be used. Preferably, however, the movable and pivotable clamps described herein can be used. The above-mentioned further preferred features can also be implemented in this lunchbox. The above features are thus combined with the features of the second variant and disclosed in this text without referring back to all features of the first variant.

Preferably, the lunchbox according to the invention is configured to be portable.

Reference is made below to the terms used herein. The term “preparation” is understood to mean in this text in principle heating up an already prepared meal. In principle, a meal can be heated up by supplying heat, whether by means of pure heat transfer and/or by supplying steam, for example water vapor. In the broader sense, the term “preparation” can also be understood here to mean boiling, also cooking, food, for example boiling potatoes or vegetables until tender. Some of the embodiments according to the invention only permit the meals to be heated up, while other embodiments also permit the food to be boiled or cooked.

Steaming, also called steam cooking, is an increasingly popular preparation method, not only due to the health benefits thereof. Meals can also be heated up or, with an extended energy supply, also cooked by means of a steamer. This type of preparation is generally called steam cooking. The advantage of heating up by using a steamer, in particular, is that the meals do not dry out.

A sealed closure within the meaning of this text is liquid-tight and gas-tight such that it meets the requirements for storing, transporting and preparing food, depending on the purpose of use of the lunchbox.

In preferred embodiments, the lunchbox has a sealingly closed through-opening to the food cavity in the lid. The through-opening can be opened for releasing a negative pressure in the food cavity. Preferably, the sealed closure can be opened by hand and/or it opens automatically in the case of a predetermined negative pressure in the food cavity. As a result, even in the case of negative pressure it is ensured that the lid of the lunchbox can be lifted away from the cavity and access to the food is possible. The closure is preferably a stopper which can be manually removed, or a valve which can be manually and/or automatically activated.

The use of such a sealed closure in the lid for the purpose of releasing a negative pressure in the cavity located therebelow can also be implemented in other lunchboxes, in particular in the known lunchboxes. A lunchbox with such a sealed closure is thus additionally claimed as a separate invention in its own right.

### BRIEF DESCRIPTION OF THE DRAWINGS

A preferred embodiment of the invention is described in the following with reference to the drawings, which are for the purpose of illustrating the present preferred embodiments of the invention and not for the purpose of limiting the same. In the drawings,

FIG. 1 shows an exploded view of a lunchbox according to the invention;

FIG. 2 shows a perspective view of the lunchbox according to FIG. 1 in the closed state;

FIG. 3 shows a view of the lunchbox according to FIG. 2 from the front;

FIG. 4 shows a side view of the lunchbox according to FIG. 2;

FIG. 5 shows a section of the lunchbox according to FIG. 3 along B-B;

FIG. 6 shows a section of the lunchbox according to FIG. 4 along C-C;

FIG. 7 shows a perspective view of the lunchbox according to FIG. 1 with a partially open closure;

FIG. 8 shows a view of the lunchbox according to FIG. 7 from the front with the lifted lid;

FIG. 9 shows a side view of the lunchbox according to FIG. 7;

FIG. 10 shows a section of the lunchbox according to FIG. 8 along B-B;

FIG. 11 shows a section of the lunchbox according to FIG. 9 along C-C;

FIG. 12 shows a view of the lunchbox according to FIG. 1 in a position for steaming;

FIG. 13 shows a side view of the lunchbox according to FIG. 12;

FIG. 14 shows a section of the lunchbox according to FIG. 12 along B-B;

FIG. 15 shows a section of the lunchbox according to FIG. 13 along C-C;

FIG. 16 shows a perspective view of the lunchbox according to FIG. 1 in the steaming position with the lifted lid;

FIG. 17 shows an exploded view of a lid and a closure of the lunchbox according to FIG. 1,

FIG. 18 shows a perspective view of a base part of the lunchbox according to FIG. 1;

FIG. 19 shows a perspective view of a detail of the base part according to FIG. 18;

FIG. 20 shows a view of the base part according to FIG. 18 from the front;

FIG. 21 shows a perspective view of a clamp of the closure of the lunchbox according to FIG. 1;

FIG. 22 shows a further perspective view of a clamp according to FIG. 21;

FIG. 23 shows a perspective, partially transparent view of the lunchbox according to FIG. 8 with only part of the closure;

FIG. 24 shows a perspective view of the detail of the lunchbox according to FIG. 23;

FIG. 25 shows a view of a variant of the lunchbox according to FIG. 2 from the front;

FIG. 26 shows a perspective view of a stopper of the lunchbox according to FIG. 25 and

FIG. 27 shows a side view of the stopper according to FIG. 26.

### DESCRIPTION OF PREFERRED EMBODIMENTS

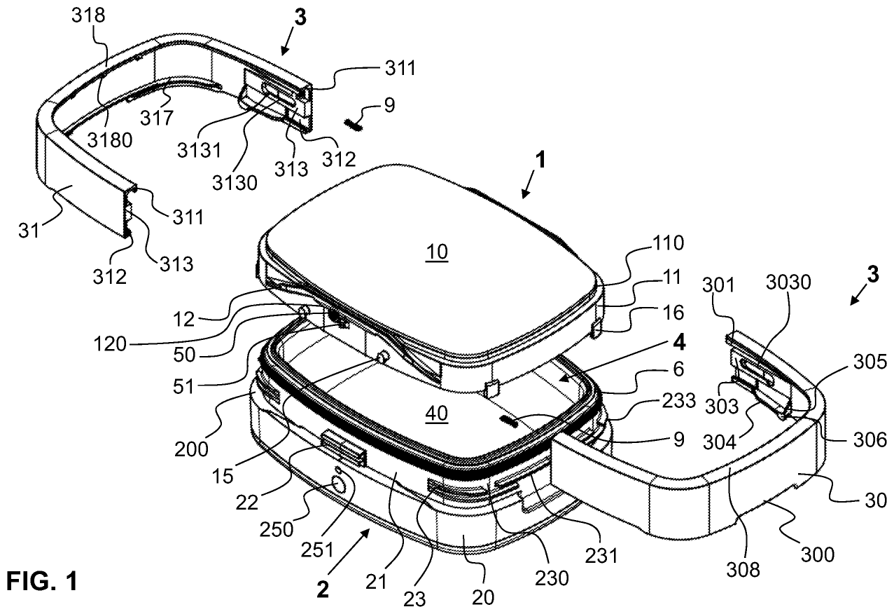

FIG. 1 shows an exploded view of a portable lunchbox according to the invention, which is suitable for storing, transporting and preparing food.

This lunchbox is a development of the lunchbox according to WO 2020/064848 A1. In this lunchbox according to the invention, it is also possible to select whether the food is merely to be heated up or whether steam is also to be applied, i.e. whether it is to be steamed.

The heating unit, the electronics and the controller are preferably configured to be the same in the lunchbox according to the invention as is described in WO 2020/064848 A1. In this text, reference is explicitly made thereto. Other parts of the lunchbox, which are potentially not described here in detail, are also preferably configured as described in WO 2020/064848 A1.

The lunchbox according to the invention according to the figures has a base part 2 which is configured to be open at the top and a lid 1 which closes this base part 2. A food cavity 40 for receiving the food is configured in the base part 2. The food cavity 40 can consist of a single space, as shown here, or it can be divided into two or more sub-regions. The food cavity 40 is preferably formed by a shell 4 which is inserted into the base part 2. The shell 4 can preferably be removed by hand in a simple manner from the base part 2 so that the food can be eaten directly from the shell after the shell 4 has been removed.

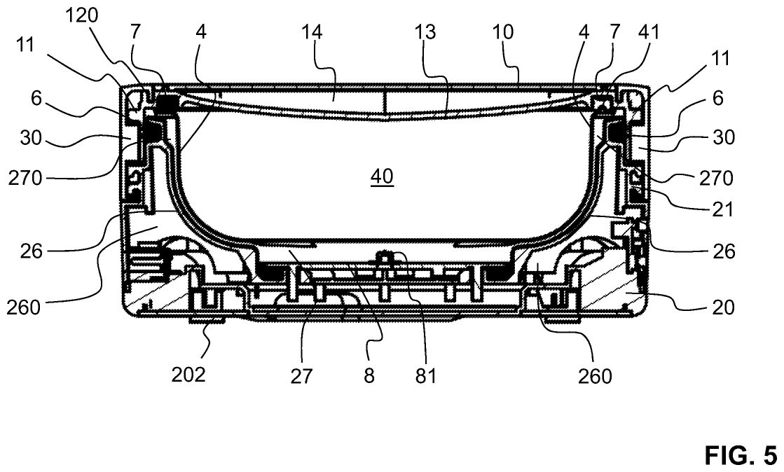

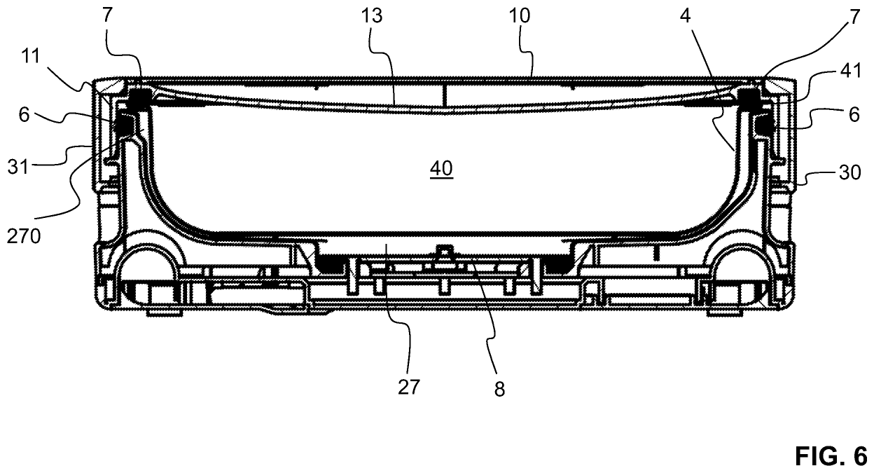

Preferably, the shell 4 is configured as described in detail in WO 2020/064848 A1. The shell 4 preferably has a peripheral upper edge 41 which forms an outwardly protruding flange (FIGS. 5 and 6).

The base part 2, when the lunchbox is also configured for heating and/or steaming, preferably has an actuating button 250 and a function display 251 which are shown by way of example in FIG. 1.

The lid 1 can be positioned on the base part 2. The lid 1 preferably can be entirely removed from the base part 2. The base part 2 is preferably configured to be approximately cuboidal. The lid 1 is as flat as possible. As a result, preferably a plurality of lunchboxes can be stacked on top of one another.

The lid 1 can be fixed by means of a closure 3 on the container 2. The closure 3 has two clamps 30, 31. The clamps 30, 31 can also be called clips.

The individual elements of the lid 1, the base part 2 and the closure 3 are explained below in the text by way of FIG. 1 and the further figures.

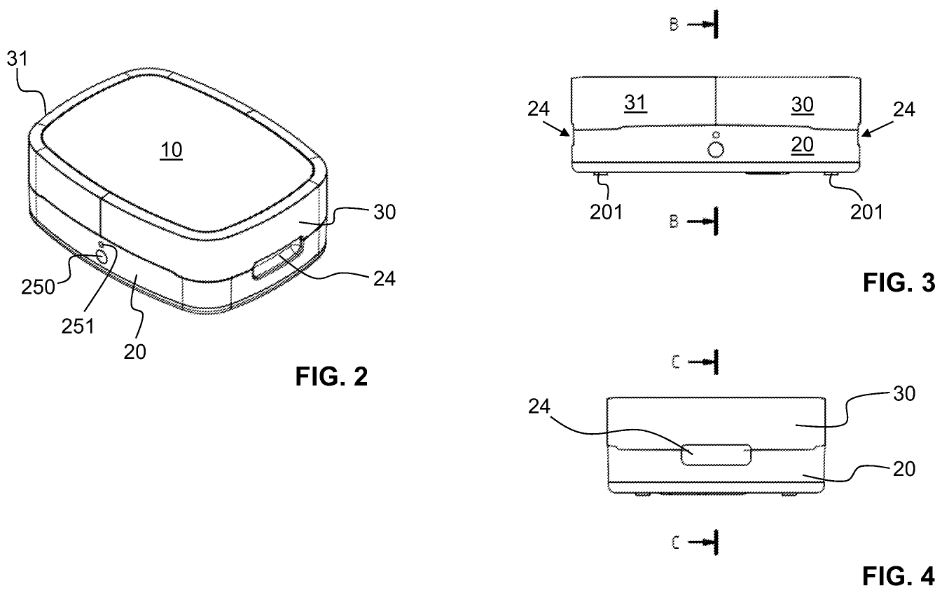

In FIG. 2 the lunchbox is shown in a first sealingly closed state. In this state, the lunchbox can be transported and the food stored therein. In this state, the food which is located in the food cavity can also be warmed or heated to a desired temperature. FIGS. 3 and 4 show the lunchbox in the same state.

In FIGS. 5 and 6 the inner construction of the lunchbox can be identified. The base part 2 preferably has an approximately planar lower face and preferably feet 202. As a result, a secure positioning on table surfaces or other planar surfaces is ensured.

As can be clearly identified in FIG. 1 the base part 2 has a lower region 20 and an upper region 21 inwardly offset via a step 200. The two regions 20, 21 are preferably configured together in one piece.

In FIGS. 5 and 6 it can be clearly identified that the base part 2 preferably has a double wall, wherein an intermediate space between the outer housing and an inner wall 26 is preferably configured to be hollow. This chamber has the reference sign 260 in the figures. The inner wall 26 forms a receiving region for the shell 4. The shell 4 is preferably positioned in its lower region on ribs, not visible here, arranged in the base part 2. The upper edge 41 of the shell preferably terminates spaced apart from the upper edge of the base part 2. The shell 4 runs spaced apart from the inner wall 26 so that a free space 270 is configured between the inner wall 26 and the shell 4.

The base part 2 forms below the shell 4 a hollow space which serves as a water cavity 27. This water cavity 27 can be filled with water when the shell 4 has been removed from the base part 2. Depending on the embodiment, it can also be filled when the shell 4 is inserted.

The water cavity 27, also called the heating cavity, is closed downwardly by an inner base which has an electronics and heating unit 8. This arrangement is preferably configured the same or similar to WO 2020/064848 A1 and thus is not discussed here in more detail. It has at least one heating element, a control unit and preferably at least one temperature sensor 81, wherein the temperature sensor 81 preferably protrudes into the water cavity 27. The temperature sensor serves for monitoring the water temperature in the water cavity 27. The temperature sensor delivers its measured values to the control unit which accordingly controls the at least one heating element.

The lid 1 can be configured in one piece. Preferably, it has a frame 11 in which a cover plate 10 is inserted. The cover plate 10 is preferably configured to be planar at least on its upper outer face.

Below the cover plate 10 the frame 11 forms a preferably downwardly curved wall 13. The intermediate space between the cover plate 10 and the curved wall 13 forms a chamber 14 which, for example, is hollow. Alternatively, it is filled with an insulating material or an insulating gas or is evacuated.

The frame 11 has a horizontally running peripheral step 110. This can be clearly identified in FIG. 1. A protruding ramp 12 is integrally formed on the outer face of each of two longer side walls of the frame 11. The ramps 12 are configured to be mirror-symmetrical with respect to a central horizontally running region. The ramps thus form a rising and a falling ramp region. The central horizontally running region forms a groove 120. The ramp 12 can be clearly identified in FIG. 1 and the groove 120 can be clearly identified in FIG. 5.

As can be identified in FIG. 1, below the ramp 12 two protruding studs 15 are arranged on the frame 11. Preferably, the studs are configured in one piece with the frame 11, as are the ramps 12.

Moreover, two outwardly and downwardly protruding spacers 16 are arranged or integrally formed on the shorter sides of the frame 11 on each side. The spacers 16 on the first side are not positioned at the same point as the spacers 16 on the opposing second side.

The base part 2 has in its upper region 21 laterally protruding guide ribs 22, 23. First guide ribs 22 are located centrally on the longer side. Second guide ribs are located in the rounded transition between the longer and the shorter sides. The first and second guide ribs 22, 23 form in each case two guide channels, the use thereof being described below in more detail.

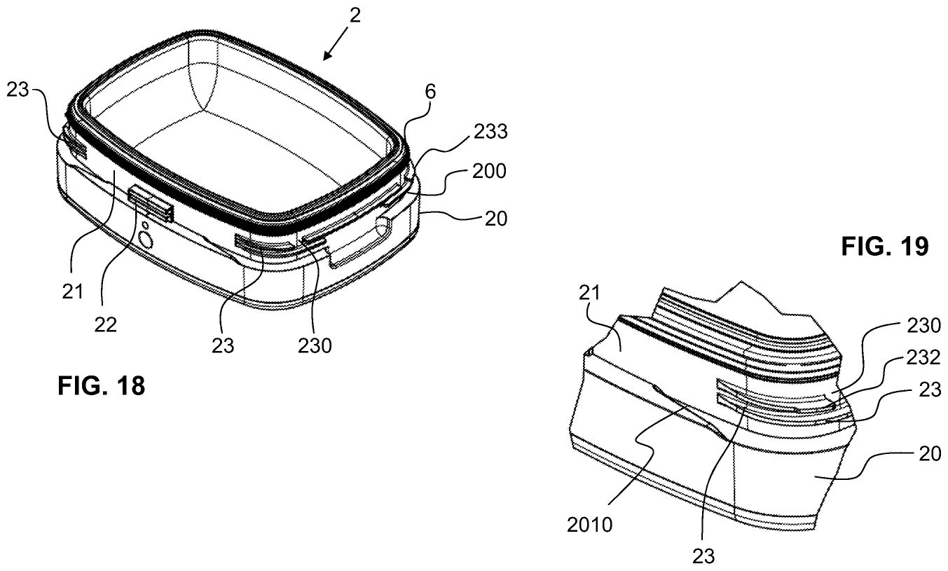

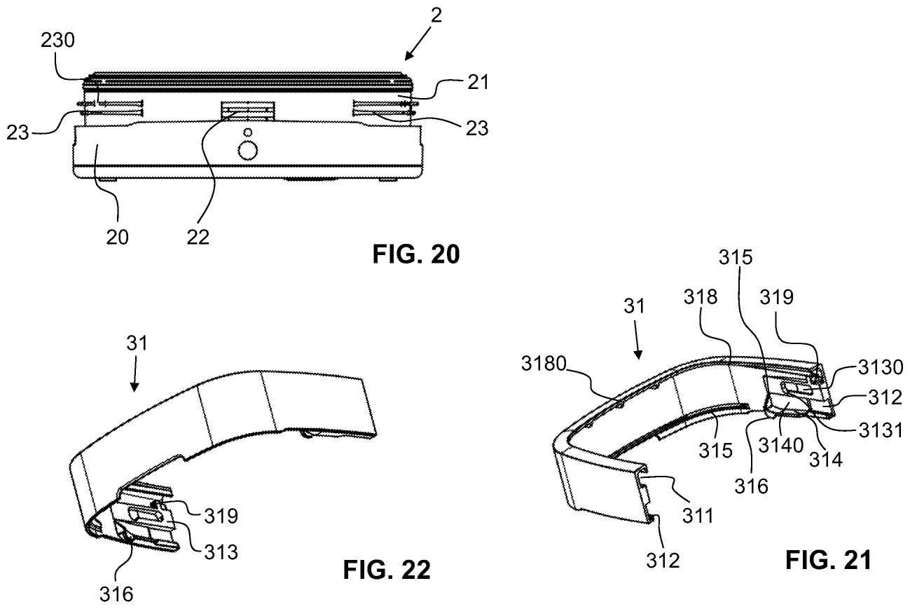

The second guide ribs 23 have in each case an interruption 230 in the upper region 21 in their upper channels. The interruptions 230 are arranged at a different point on the one side from the interruptions 230 on the other side. This can be clearly identified in FIGS. 18 to 20.

The lid 1 can be positioned on the base part 2 in two rotary positions. In a first rotary position the spacers 16 engage in the interruptions 230. The frame 11 of the lid 1 is positioned with its lower peripheral edge on the central upper edge 231 of the second guide ribs 23. This can be clearly identified in FIG. 6.

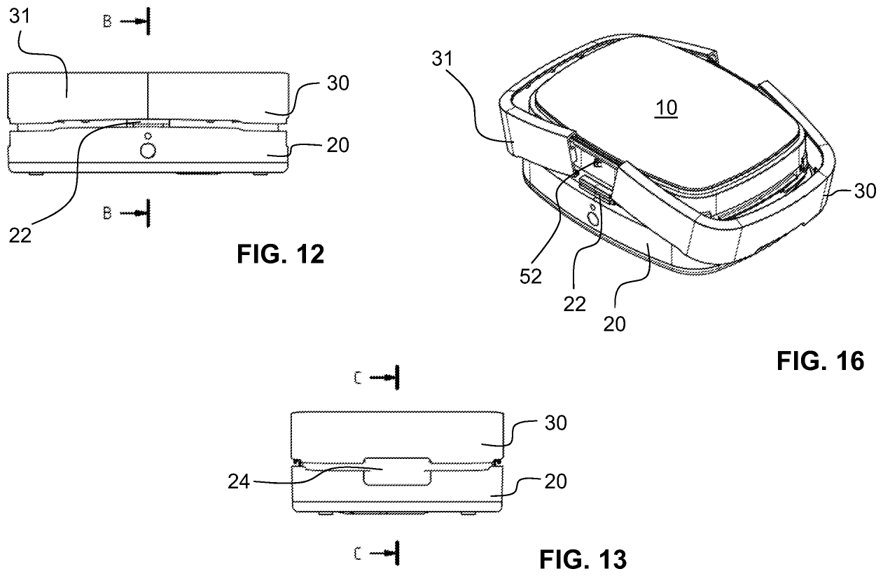

If the lid is rotated by 180°, the spacers 16 can no longer engage in the interruptions 230 due to the different arrangement. The spacers are positioned adjacent thereto on the upper edge of the second guide ribs 23. Preferably, the upper edge is configured to be slightly wider in this region 232 than the remaining upper edge of the second guide rib 23. This wider design can be clearly identified in FIG. 19. In this second rotary position of the lid 1, the lower edge of the frame 11 terminates spaced apart from the upper edge of the guide 35 ribs 22, 23. The lid 1 is thus arranged higher than in the first rotary position, and the chamber formed thereby in the interior of the lunchbox is thus larger. This is shown in FIGS. 12 to 15.

In other embodiments, additionally or alternatively the interruptions 230 and the spacers 16 can also be configured on the longer sides of the base part 2 or the lid 1. In further embodiments, some of the interruptions or all of the interruptions are arranged in the lid and some of the spacers or all of the spacers are arranged in the base part.

A peripheral first seal 6, in the form of a sealing ring here, is arranged on the outer face of the base part 2. A downwardly oriented peripheral second seal 7, also in the form of a sealing ring here, is arranged in the lid 1. As can be identified in FIGS. 5 and 6, the first seal 6 is sealed with respect to the internal peripheral side wall of the frame 11. This applies not only to the first rotary position of the lid 1 which is shown in FIGS. 5 and 6, but also to the second rotary position which is shown in FIGS. 12 to 15.

The second seal 7 is sealingly positioned in the first rotary position of the lid 1 on the upper edge 41 of the shell 4. As a result, a sealed separation is present between the food cavity 40 and the free space 270 and the water cavity 27. In this state, the lunchbox serves for warming or heating the food without the addition of steam, and for transporting and storage. This can be clearly identified in FIGS. 5 and 6.

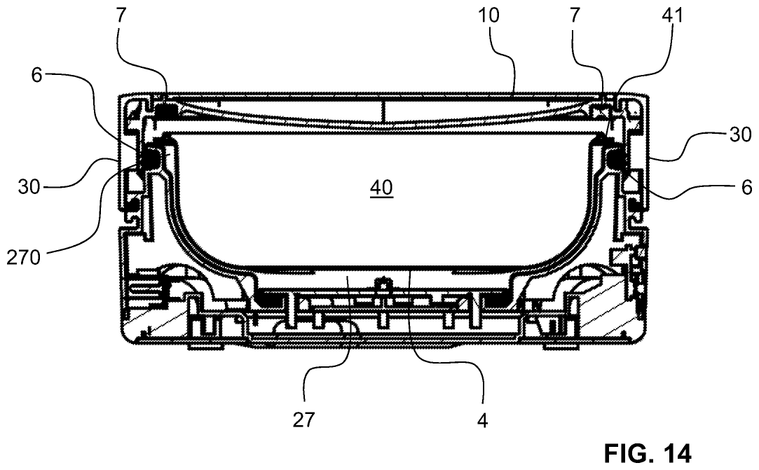

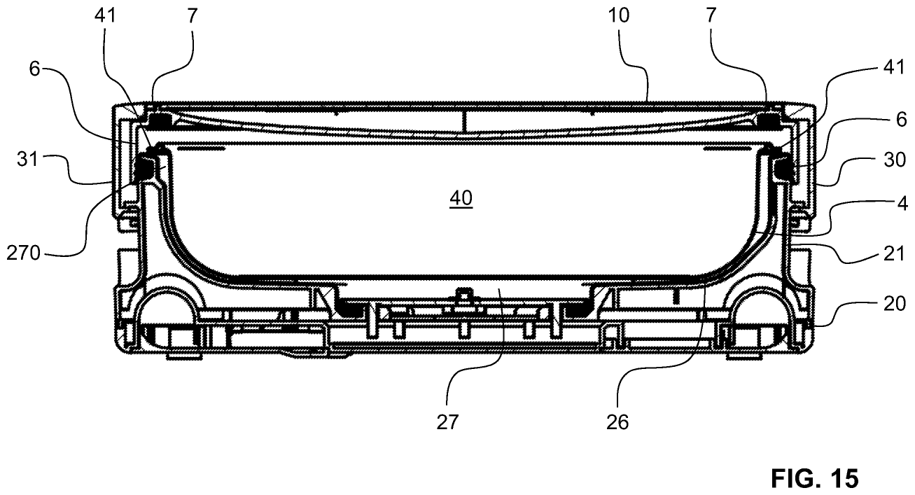

In the second rotary position of the lid 1, the second seal 7 terminates spaced apart from the upper edge 41 of the shell 4. This can be identified in FIGS. 14 and 15. An open connection between the water cavity 27 and the food cavity 40 is provided via the free space 270. In this second closed state which is still outwardly sealed, the lunchbox serves not only for heating up food but also for the application of steam, i.e. for steaming.

By a simple rotation of the lid 1 the user can thus select whether they wish to prepare the food by warming or heating or whether they wish to steam the food. The first rotary position of the lid 1 also serves for storing and for transporting, since in this case the shell 4 is sealed with respect to the remaining interior of the lunchbox.

The rotary position can be labeled on the lid so that the user easily identifies the position. However, this is not absolutely necessary. As can be identified by comparing FIGS. 3 and 12, the user also identifies the position and thus the state of readiness of the lunchbox by the distance of the clamps 30, 31 from the base part 2, i.e. by the presence or absence of the horizontally peripheral gap.

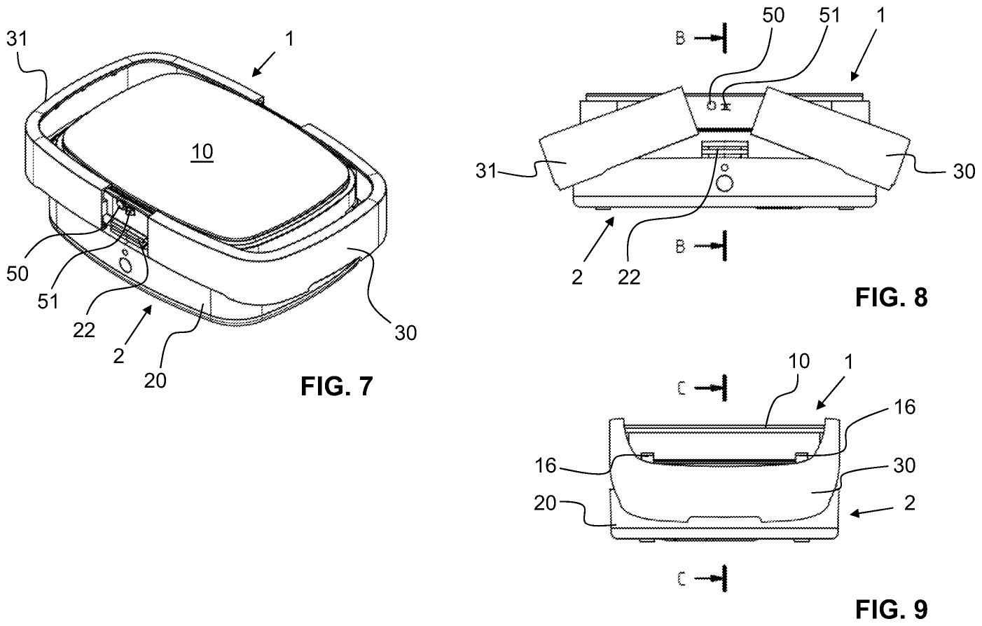

In FIG. 7 the lunchbox according to the invention is shown in its first rotary position and in the partially open state. For opening, the two clamps 30, 31 are pulled in horizontally opposing directions. So that the clamps 30, 31 can be easily gripped by hand, a niche 24 is present in the base part 2 and a recess 300, 310 is present in the clamps. This can be identified in FIGS. 1 and 2.

If the clamps 30, 31 are pulled out further, they reach a point at which they can be tilted downwardly by slight manual pressure. In other embodiments they tilt automatically downwardly due to their own weight. This can be identified in FIGS. 8 and 9. In FIG. 16 the same situation is shown, wherein here the lid 1 is in the second rotary position.

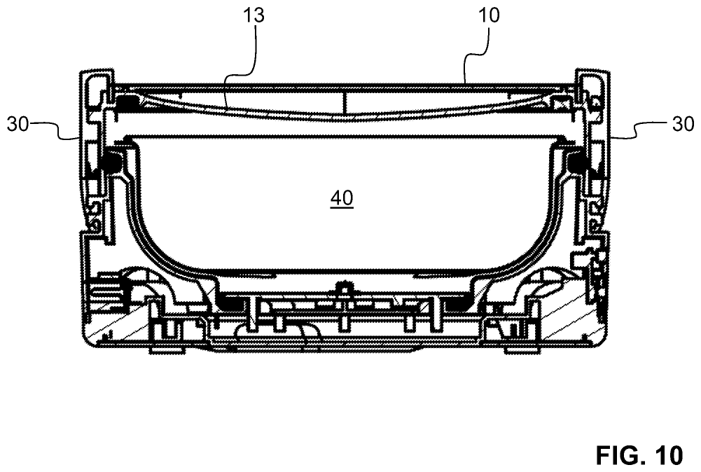

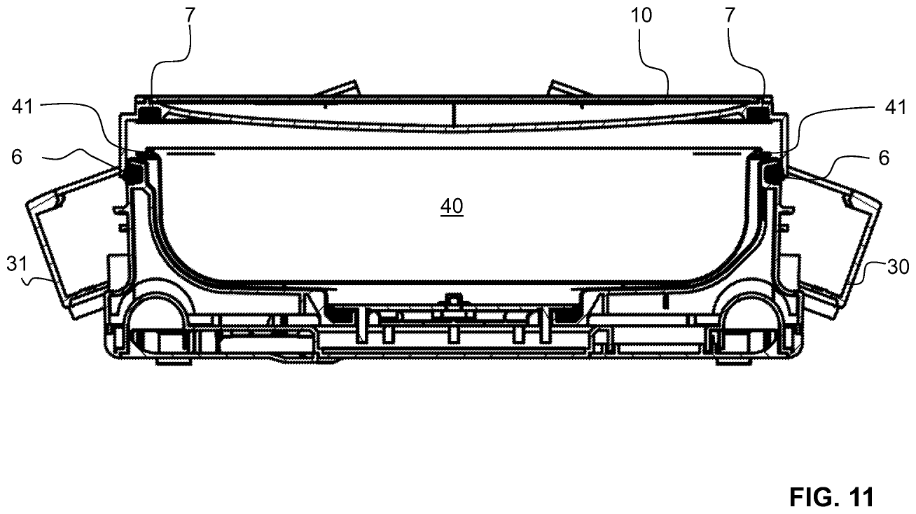

As shown in FIGS. 10 and 11, the lid 1 is lifted due to this folding down of the clamps 30, 31. The clamps 30, 31 remain in this position due to their own weight. The lid 1 remains in the lifted position due to the bearing or positioning on the seal. The user can now lift the lid 1 at a time which is appropriate and open the food cavity comprising the prepared meals. The lid 1 can preferably be removed entirely from the base part 2 and the shell 4 can then be lifted out of the base part 2. The same applies to the lunchbox when the lid 1 is in the second rotary position, as shown in FIG. 16.

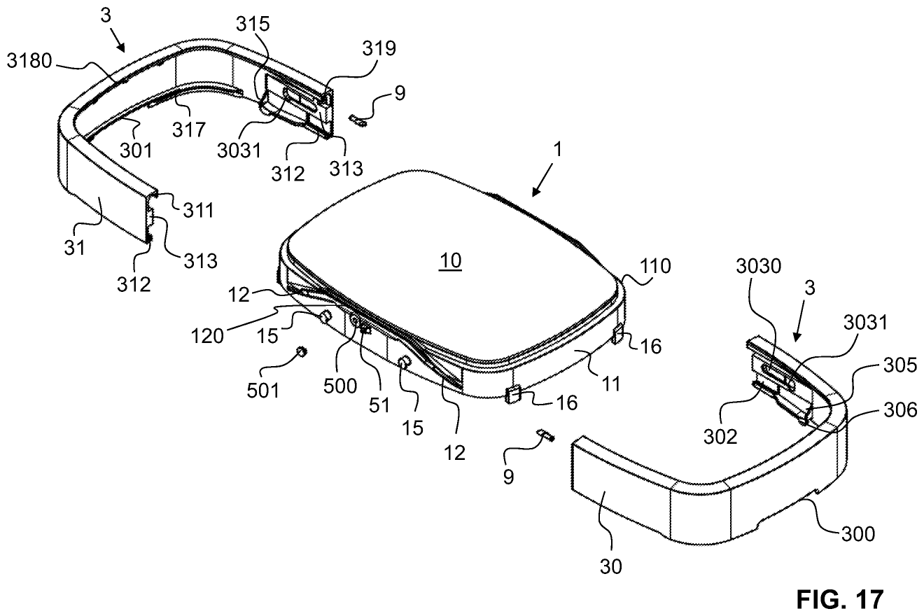

As shown in FIG. 1, the lid 1 has two openings in the central region of one of its longer side walls. One of the openings is a simple through-hole into the interior of the lunchbox and serves as an air outlet opening 51. The other opening is provided with a pressure relief valve 50. The pressure relief valve 50 has a valve seat 500, which is visible in FIG. 17, and a valve diaphragm 501. Preferably, the pressure relief valve 50 is a simple diaphragm umbrella valve. Other types of valve can also be used, however. The air through-opening 51 in this example is arranged on a wedge which is integrally formed on the lid 1, wherein the surface having the air through-opening 51 faces a front face of the first clamp 30. A seal 9, in the form of a flexible stopper here, is arranged in the first clamp 30. The second clamp 31 also has a seal 9, and this is preferably configured the same. This seal is located, however, on the opposing longitudinal side with respect to the lid 1. This can be identified in FIGS. 1, 17, 21 and 22. A further wedge with an air through-opening 51 is present on the opposing longitudinal side of the lid 1, wherein this opening faces the second clamp 31. In this example, there is no pressure relief valve 50 on this opposing side. This opposing side is visible in FIG. 16. Alternatively, more than two air through-openings 51 can be formed. Other embodiments have only a single air through-opening 51. Moreover, it is possible for no pressure relief valve 50 to be present or for more than one pressure relief valve 50 to be present. If more than one pressure relief valve 50 is present, they can open with the same overpressure or in other embodiments they open at variable overpressure, i.e. in stages.

When the clamps 30, 31 are closed, the air through-openings 51 are preferably only sealed shortly before the full closure. As a result, air can escape from the interior of the lunchbox during the closing process. The closure is facilitated thereby.

As can be identified in FIGS. 7, 8 and 16, the air through-openings 51 can be opened up when the clamps 30, 31 are moved. In the closed state, the seals 9 which are held on the clamps 30, 31 bear sealingly against the air through-openings 51. By opening up this air through-opening 51, steam and hot air can now escape from the interior of the lunchbox. This is already the case when the clamps 30, 31 are moved horizontally according to FIG. 7 and even more so when the lid 1 is still held in the lifted but closed position with the folded down clamps 30, 31 according to FIGS. 8 and 16. The air through-openings 51 are located spaced apart from the region of the clamp 30, 31 which has to be held by the user for the actuation thereof. As a result, the risk of scalding the user is minimized. Even people or animals in the vicinity are hardly sprayed with steam or hot air since the lid 1 is not immediately lifted but the overpressure can initially escape through the air through-openings 51.

Thus with the clamps pulled out or with the clamps folded down 30, 31, it is possible to wait until no steam or hardly any more steam exits from the air through-openings 51 before the lid 1 is removed from the base part 2 and the food cavity 40 is opened up.

The pressure relief valve 50 is ready for use at all times, i.e. even in the closed state of the lunchbox when the clamps 30, 31 are pushed together and preferably in contact, as shown in FIG. 2. The concealed arrangement of the pressure relief valve has the advantage that when the lunchbox is closed and the clamps 30, 31 are pushed together the steam initially passes into the clamps 30, 31 and is dispersed outwardly. As a result, scalding is not possible.

By way of this exemplary embodiment it is described hereinafter how the movement and the folding down of the clamps 30, 31 is made possible and how a greater seal of the lunchbox is ensured. These functions and properties can also be individually achieved so that embodiments which do not have all of the features mentioned below but merely those features which are required for fulfilling the respective function or property are also encompassed by the description. Additionally, such functions and properties can also be achieved by other means which are evident to a person skilled in the art from their specialist knowledge. This is also encompassed in the description.

In FIGS. 1, 17, 21 and 22 the clamps 30, 31 can be clearly identified. The features of the second clamp 31 are described and the reference signs thereof are mentioned below. The first clamp 30 is preferably configured to be the same in terms of shape and size. Thus the description of the second clamp 31 specified in this text can also be applied to the first clamp 30 and, instead of the reference sign 31x, the reference signs 30x can be used, where x is a number from 1 to 9. The same applies to the four digit reference signs.

The second clamp 31 is configured to be U-shaped. The second clamp has two limbs and a web connecting these limbs. Apart from the recess, the limbs and the web preferably have the same height which is also preferably approximately constant.

The upper face of the clamp 31 has an inwardly protruding flange 318. This flange is bent downwardly in a U-shape in the region of the free ends of the limbs, such that a downwardly open U-shaped groove is configured. This groove serves as an upper guide 311. In the region of the web the flange 318 has at least one rib, preferably a plurality of downwardly oriented ribs, which serve as hold-down devices 3180. The flange 318 in the closed state of the lunchbox is positioned on the step 11 of the lid 1. The hold-down devices 3180 push the lid 1 downwardly toward the base part 2. The upper face of the two clamps 30, 31 and the lid 1 preferably form a planar surface, as shown in FIG. 2.

An inwardly protruding latching block 303, 313 is configured on the inner face of the two limbs of each clamp 30, 31 below the upper guide 301, 311. The latching block has a guide aperture 3030, 3130 with an insertion extension 3031, 3131. When assembling the lunchbox, the two clamps 30, 31 are pushed together parallel to the lid 1 until the studs 15 of the lid 1 engage in the insertion extension 3031, 3131 and engage in the slightly narrower guide aperture 3030, 3130.

A receiver 309, 319 for fastening the aforementioned seal 9 is arranged above the latching block 303, 313 (see FIGS. 17, 21 and 22). The seal 9 is preferably configured to be bar-shaped or button-shaped.

A lower guide 302, 312 is configured below the latching block 303, 313 in the region of the free ends of the limbs of the clamps 30, 31. This lower guide also has the shape of an upwardly open U-shaped groove. An extended, approximately horizontally running plate 304, 314 which terminates via an oblique surface in a rear wall 305, 315 follows the lower guides 302, 312. A downwardly protruding lug 306, 316 is configured in the region of the oblique surface. The inner wall of the limbs in the region of the plate 304, 314 forms an inwardly protruding region 3040, 3140. An inwardly protruding web which forms a rear guide 307, 317 runs in the lower region of the web of the clamps 30, 31.

The lower guide 302, 312 engages in the first guide ribs 22 of the base part 2. Depending on the rotary position of the lid 1 with respect to the base part 2, the lower guide 302, 312 slides along the upper or the lower rib of the first guide ribs 22. In the position for steaming, i.e. with a slightly raised lid 1, it is connected to the upper first guide rib 22, and in the heating, transport and storage position it is connected to the lower first guide rib 22.

Accordingly, the rear guides 307, 317 cooperate with the second guide ribs 23. A cooperation is also present either with the upper or the lower rib of the second guide ribs 23. This can be derived from FIG. 1. The sides, not fully shown, of the base part 2 also have corresponding first or second guide ribs 22, 23.

The groove 120 of the lid 1 cooperates with the upper guide 301, 311 when the clamps 30, 31 are closed, i.e. when pushed together. The two grooves 120, 301, 311 engage in one another.

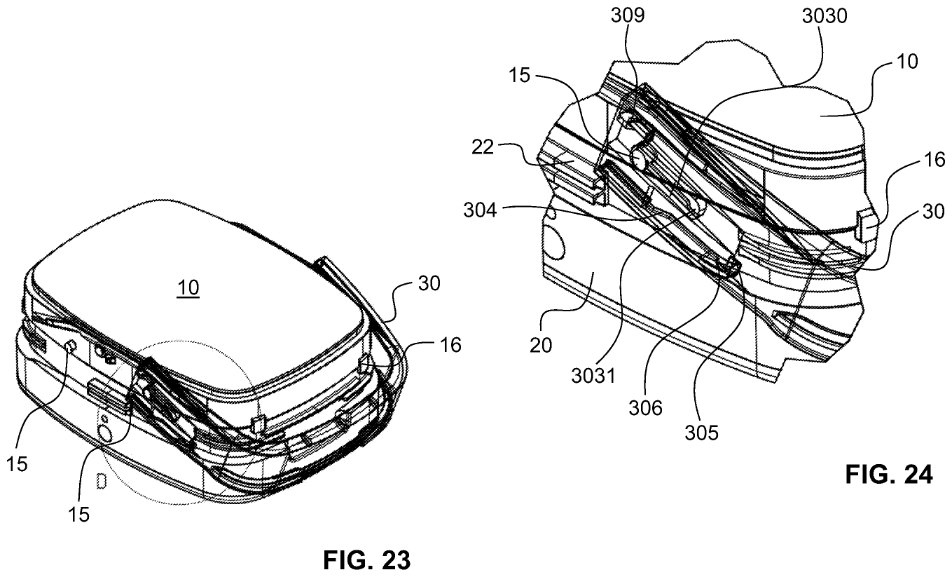

In FIGS. 23 and 24 the situation with the downwardly pivoted clamps 30, 31 is shown, as results when the lunchbox is opened for the escape of steam or for cooling the heated food. The clamps are shown here in the open position. Depending on the embodiment, the pivotability is already possible in a position which is moved with respect to the closed position but which is not yet the open position.

The studs 15 are located on the respective foremost end of the guide aperture 3030, 3130. This forms a stop. The clamp 30, 31 cannot be pulled apart again. Preferably, the foremost lower edge of the clamp is positioned on the first guide ribs 22. This facilitates a subsequent pushing together of the clamps 30, 31.

The step 200 has a vertical oblique surface 2010 which in the direction of the first guide ribs 22 is inclined from an outer edge of the step 200 to the outer wall of the upper region 21.

When closing the clamps 30, 31, the lug 306, 316 slides along this oblique surface 2010. As a result, it is ensured that the clamp 30, 31 is not pushed outwardly but the upper guide 301, 311 is inserted again in the desired manner in the upper groove 120 of the ramp 12 of the lid 1. By pushing the clamp 30, 31 downwardly, the clamp 30, 31 slides to the side away from the base part 2. The clamp 30, 31 would thus no longer be positioned on the base part 2. This is prevented due to the lug 306, 316, and a recess.

The latching block 303, 313 and/or the thickened protruding region 3040, 3140 of the plate 304, 314 additionally push the side walls of the lid 1 inwardly and thus increase the seal when the lunchbox is closed. When the clamps 30, 31 are locked, the front end of the plate 304, 314 and/or the thickened region 3040, 3140 forms a stop for the front face of the first guide ribs 22.

In other embodiments, when locking the clamps and/or pressing on the lid for ensuring the seal, the pivotability and/or the guidance is achieved in a manner which is obvious to a person skilled in the art and which, for example, is known from the prior art.

The second guide ribs 23 preferably have at their free ends in each case a hook 233 which is easily latched into the rear guide 307, 317 and thus holds the clamps 30, 31 in the closed position. In other embodiments, other fixing means are present or the clamps 30, 31 are held in their position due to frictional forces. This can be identified in FIGS. 1 and 18.

The configuration of the studs 15 and the guide aperture 3030, 3130 prevents the clamps 30, 31 from being able to be removed when pivoted or when pulled out from the lid 1. The removal is preferably only possible when the two clamps 30, 31 are pushed toward one another, i.e. the clamps form a closed closure.

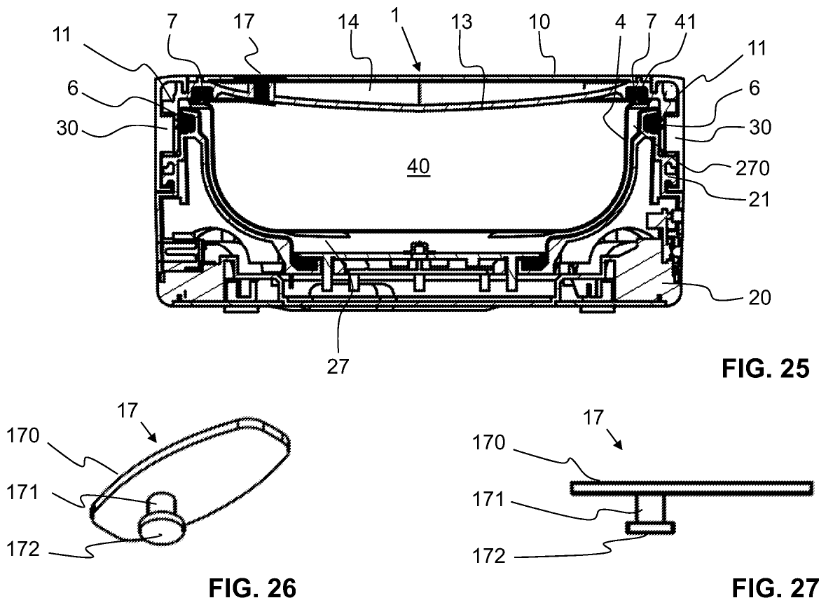

A variant of this exemplary embodiment is shown in FIG. 25. A stopper 17 is arranged in a through-opening of the lid 1. This stopper forms a sealed closure to the food cavity 40 of the shell 4. However, if required, the stopper can be opened by hand. This requirement is present, for example, when a negative pressure in the food cavity 40 impedes or prevents the lid 1 from being lifted off and thus the lunchbox from being opened. Such negative pressures can be produced, for example, when a heated-up contents of the shell 4 cools again without the lid 1 being lifted or removed in the intervening time.

The stopper 17 is preferably configured such that in the case of overpressure in the food cavity 40 it is not automatically lifted off and and is not able to open up the through-opening. Preferably, the stopper has a shape which can be identified in FIGS. 26 and 27. The stopper has a head 170 in the form of a plate with a first bottom surface, a neck 171 which adjoins thereto and which is preferably configured to be circular cylindrical, and a foot 172 which is arranged at the second end of the neck 171, and which is also preferably plate-shaped with a second bottom surface. The first bottom surface is preferably of the same size or substantially larger than the second bottom surface.

As can be identified in FIG. 25, the foot 172 bears against the lower face, here the curved wall 13, of the lid 1 and thereby prevents an automatic lifting of the lid when overpressure prevails in the cavity 40.

The head 170 is either positioned on the surface of the cover plate 10 of the lid 1 or is arranged in a recess of the cover plate 10 which corresponds in terms of shape. It can be lifted if required in order to break the seal and to release the negative pressure in the cavity. Depending on the embodiment, it can be also completely removed.

Preferably, the stopper is produced from an elastic material, for example from silicone.

The stopper can also have different forms. Moreover, instead of a stopper a valve can also be arranged in the lid, the valve opening automatically in the case of a predetermined negative pressure in the cavity.

The lunchbox according to the invention allows safe opening of the lid without the risk of scalding the user and with little expenditure of force. It also permits optimal sealing.

LIST OF REFERENCE SIGNS

| | |
|---|---|
| 1 | Lid |
| 10 | Cover plate |
| 110 | Step |
| 11 | Frame |
| 12 | Ramp |
| 120 | Groove |
| 13 | Curved wall |
| 14 | Chamber |
| 15 | Stud |
| 16 | Spacer |
| 17 | Stopper |
| 170 | Head |
| 171 | Neck |
| 172 | Foot |
| 2 | Base part |
| 20 | Lower region |
| 200 | Step |
| 2010 | Oblique surface |
| 202 | Foot |
| 21 | Upper region |
| 22 | First guide ribs |
| 23 | Second guide ribs |
| 230 | Interruption |
| 231 | Central upper edge |
| 232 | Extended region |
| 233 | Hook |
| 24 | Niche |
| 250 | Actuating button |
| 251 | Display |
| 26 | Inner wall |
| 260 | Chamber |
| 27 | Water cavity |
| 270 | Free space |
| 3 | Closure |
| 30 | First clamp |
| 300 | Recess |
| 301 | Upper guide |
| 302 | Lower guide |
| 303 | Latching block |
| 3030 | Guide aperture |
| 3031 | Insertion extension |
| 304 | Plate |
| 3040 | Protruding region |
| 305 | Rear wall |
| 306 | Lug |
| 307 | Rear guide |
| 308 | Flange |
| 3080 | Hold-down device |
| 309 | Receiver |
| 31 | Second clamp |
| 310 | Recess |
| 311 | Upper guide |
| 312 | Lower guide |
| 313 | Latching block |
| 3130 | Guide aperture |
| 3131 | Insertion extension |
| 314 | Plate |
| 3140 | Protruding region |
| 315 | Rear wall |
| 316 | Lug |
| 317 | Rear guide |
| 318 | Flange |
| 3180 | Hold-down device |
| 319 | Receiver |
| 4 | Shell |
| 40 | Food cavity |
| 41 | Upper edge |
| 50 | Pressure relief valve |
| 500 | Valve seat |
| 501 | Valve diaphragm |
| 51 | Air through-opening |
| 6 | First seal |
| 7 | Second seal |
| 8 | Electronics and heating unit |
| 81 | Temperature sensor |
| 9 | Seal |

1. A lunchbox comprising
a base part having a food cavity for receiving food,
a lid sealingly closing the base part and
a closure for closing the lunchbox by fixing the lid on the base part,
wherein the closure comprises at least one locking element, the locking element being moveable from a closed position into an open position with respect to the base part and the lid,
wherein
at least one lifting element is provided, said lifting element lifting the lid from the base part when the locking element is in a position in which it is moved with respect to the closed position.

2. The lunchbox as claimed in claim 1, wherein the at least one locking element comprises a clamp with two arms and a web connecting the two arms,
wherein the clamp can be moved from the closed position into the open position with respect to the base part and the lid, in the longitudinal direction of the arms,
wherein the at least one lifting element is the clamp and wherein the clamp is pivotable when it is in the position in which it is moved with respect to the closed position, wherein a pivoting of the clamp with respect to the base part and the lid lifts the lid from the base part.

3. The lunchbox as claimed in claim 2, wherein the closure has two clamps, which can be moved with respect to the base part and the lid in the longitudinal direction of their arms, wherein the clamps in a pushed-together state sealingly fix the lid to the base part.

4. The lunchbox as claimed in claim 1, wherein the lunchbox has at least one air through-opening which leads outwardly from an interior of the base part, wherein in the closed position the at least one locking element sealingly closes the at least one air through-opening, and wherein in a position in which it is moved with respect to the closed position the at least one locking element opens up the at least one air through-opening.

5. The lunchbox as claimed in claim 4, wherein the at least one air through-opening is arranged in the lid and wherein the air through-opening leads outwardly from the food cavity.

6. The lunchbox as claimed in claim 1, wherein the lunchbox has at least one pressure relief valve which leads outwardly from an interior of the base part, wherein at least in the closed position the pressure relief valve is covered by at least one locking element.

7. The lunchbox as claimed in claim 6, wherein the at least one pressure relief valve is arranged in the lid and wherein the pressure relief valve leads outwardly from the food cavity.

8. The lunchbox as claimed in claim 1, wherein the at least one locking element is held on the lid and wherein the lid has a guide which guides the movement of the locking element and a movement of the at least one lifting element.

9. The lunchbox as claimed in claim 1, wherein the at least one locking element is positioned on a projection or a step of the lid in order to push the lid sealingly onto the base part in the closed position.

10. The lunchbox as claimed in claim 1, wherein the lunchbox has a heating element for heating up and/or preparing food.

11. The lunchbox as claimed in claim 10, wherein the lunchbox has a water cavity for filling with water and wherein the heating element acts on the water cavity.

12. The lunchbox as claimed in claim 1, wherein a gap is formed between the food cavity and the base part, wherein the lid is sealingly positioned on the base part in a first rotary position, such that it seals the gap when the closure is closed with respect to the food cavity, and wherein the lid is positioned on the base part in a second rotary position, such that it opens up the gap when the closure is closed with respect to the food cavity.

13. The lunchbox as claimed in claim 12, wherein the lunchbox has a heating element for heating up and/or preparing food, wherein the lunchbox has a water cavity for filling with water and wherein the heating element acts on the water cavity and wherein the food cavity is sealed with respect to the water cavity in the first rotary position of the lid and wherein the food cavity is connected to the water cavity in the second rotary position of the lid, for the purpose of applying steam to the food.

14. The lunchbox as claimed in claim 12, wherein the base part has a first and a second guide and wherein when the at least one locking element is moved the at least one locking element is guided by the first guide or by the second guide of the base part as a function of the rotary position of the lid.

15. The lunchbox as claimed in claim 1, wherein a sealingly closed through-opening is arranged in the lid, the through-opening connecting the food cavity to the outside and being able to be opened for releasing a negative pressure in the food cavity.

16. A lunchbox, having
a base part having a food cavity for receiving food,
a lid sealingly closing the base part,
a closure for closing the lunchbox by fixing the lid on the base part,
an air through-opening and/or a pressure relief valve,
wherein
the closure covers the air through-opening and/or the pressure relief valve in a closed state of the lunchbox and the closure opens up the air through-opening and/or the pressure relief valve in an open state of the lunchbox.

17. The lunchbox as claimed in claim 8, wherein the movement of the at least one lifting element is a pivoting of the at least one lifting element.
